(19) United States
(12) Patent Application Publication
(10) Pub. No.: US 2014/0143235 A1
(43) Pub. Date: May 22, 2014

(54) INFORMATION OUTPUTTING METHOD AND ELECTRONIC DEVICE

(71) Applicant: Lenovo (Beijing) Co., Ltd., Beijing (CN)

(72) Inventors: Xinru Hou, Beijing (CN); Shifeng Peng, Beijing (CN)

(73) Assignee: Lenovo (Beijing) Co., Ltd., Beijing (CN)

(21) Appl. No.: 14/085,410

(22) Filed: Nov. 20, 2013

(30) Foreign Application Priority Data
Nov. 20, 2012 (CN) 201210473238.7

(51) Int. Cl. G06F 17/30

(52) U.S. Cl. CPC G06F 17/30554
USPC 707/722

(57) ABSTRACT

An information outputting method and an electronic device are provided. The method includes: acquiring a request event and a request identifier contained in the request event; searching for prestored historical record information of a request object corresponding to the request identifier; and outputting the historical record information on a display interface of a first electronic device when the request event has not been responded successfully.

This application claims the priority to Chinese Patent Application No. 201210473238.7, entitled “INFORMATION OUTPUTTING METHOD AND ELECTRONIC DEVICE”, filed with the Chinese State Intellectual Property Office on Nov. 20, 2012, which is incorporated by reference in its entirety herein.

### TECHNICAL FIELD

The disclosure relates to the field of information processing technology, and particularly to an information outputting method and device.

### BACKGROUND

With the development of communication technology and network technology, electronic devices, particularly mobile communication electronic devices such as various mobile phones and smart phones, have become people's necessary electronic products. Users transmit information to each other by various electronic devices conveniently.

When the electronic device outputs information according to user's requirement, the user usually can not acquire the information in a timely manner due to, for example, the user himself/herself, the device or the network, and the user has to wait for a long time. For example, when a user sends a call request to another electronic device of another user by an electronic device or receives a call request sent from another electronic device of another user by an electronic device, the call waiting time is usually long, thereby resulting in waste of time and device resource, and reducing user experience.

### SUMMARY

In view of the above, an information outputting method and an electronic device are disclosed, to solve the technical problem of time and device resource waste of electronic devices in the prior art.

To achieve the above object, following technical solutions are disclosed.

An information outputting method applied to a first electronic device includes:
acquiring a request event and a request identifier contained in the request event;
searching for prestored historical record information of a request object corresponding to the request identifier; and
outputting the historical record information on a display interface of the first electronic device when the request event has not been responded successfully.

Preferably, in a case where the request event is a communication request event and the request identifier is a communication identifier, the searching for historical record information of a request object corresponding to the request identifier includes:
acquiring at least one historical record image of a communication object corresponding to the communication identifier, where the historical record image is obtained from video data transmitted in a historical video communication corresponding to the communication object; and
the outputting the historical record information on a display interface of the first electronic device when the request event has not been responded successfully includes:
outputting the at least one historical record image on the display interface of the first electronic device when the communication request event has not been responded successfully.

Preferably, the acquiring at least one historical record image of a communication object corresponding to the communication identifier includes:
searching for stored historical video data of a historical communication video record of the communication object corresponding to the communication identifier; and
extracting at least one historical record image from the historical video data.

Preferably, the extracting at least one historical record image from the historical video data includes:
determining the latest historical video data of the latest video communication record of the communication object, and extracting at least one historical record image from the latest historical video data.

Preferably, the outputting the at least one historical record image on a display interface of the first electronic device when the communication request event has not been responded successfully includes:
dynamically outputting the at least one historical record image on the display interface of the first electronic device at a predetermined output speed in a response waiting time of the communication request event, where the number of the historical record images output on the display interface indicates response waiting progress.

Preferably, in a case where the communication request event is a video communication request event, the method further includes, after outputting the at least one historical record image on the display interface of the first electronic device,
recording video data transmitted via a video data communication channel after the video data communication channel is established when the video communication request event has been responded successfully.

Preferably, in a case where the communication request event is a video communication request event, the method further includes, after outputting the at least one historical record image on the display interface of the first electronic device,
extracting, from video data transmitted via a video data communication channel, and storing a predetermined number of images corresponding to the communication object after the video data communication channel is established when the video communication request event has been responded successfully.

Preferably, in a case where the request event is a communication request event, the acquiring a request event and a request identifier contained in the request event includes:
acquiring the communication request event and a communication identifier of a second electronic device contained in the communication request event when the communication request event transmitted from the second electronic device is detected; or
acquiring the communication request event and a communication identifier of a second electronic device contained in the communication request event when the communication request event transmitted to the second electronic device is detected.

Preferably, in a case where the request event is a network data request event and the request identifier is a network identifier, the searching for stored historical record information of a request object corresponding to the request identifier includes:
searching for stored historical network data of a historical access record of a request object corresponding to the network identifier; and
the outputting the historical record information on a display interface of the first electronic device when the request event has not been responded successfully includes:
outputting the historical network data on the display interface of the first electronic device when the network data request event has not been responded successfully.

An electronic device includes:
a request acquiring module, configured to acquire a request event and a request identifier contained in the request event;
an information searching module, configured to search for prestored historical record information of a request object corresponding to the request identifier;
an information outputting module, configured to output the historical record information when the request event has not been responded successfully; and
an information display module, configured to display the historical record information output from the information outputting module.

Preferably, in a case where the request event is a communication request event and the request identifier is a communication identifier, the information searching module is configured to acquire at least one historical record image of a communication object corresponding to the communication identifier, where the historical record image is obtained from video data transmitted in a historical video communication corresponding to the communication object; and
the information outputting module is configured to output the at least one historical record image when the communication request event has not been responded successfully.

Preferably, the information searching module includes:
a data searching module, configured to search for stored historical video data of a historical communication video record of the communication object corresponding to the communication identifier; and
a first extraction module, configured to extract at least one historical record image from the historical video data.

Preferably, the information outputting module is configured to dynamically output the at least one historical record image on a display interface of a first electronic device at a predetermined output speed in a response waiting time of the communication request event, where the number of the historical record images displayed on the information display module indicates response waiting progress.

Preferably, in a case where the communication request event is a video communication request event, the electronic device further includes:
a first storage module, configured to record video data transmitted via a video data communication channel after the video data communication channel is established when the video communication request event has been responded successfully.

Preferably, in a case where the communication request event is a video communication request event, the electronic device further includes:
a second extraction module, configured to extract a predetermined number of images corresponding to the communication object from video data transmitted via a video data communication channel after the video data communication channel is established when the video communication request event has been responded successfully; and
a second storage module, configured to store the predetermined number of images corresponding to the communication object extracted by the second extraction module as the historical record images.

Preferably, in a case where the request event is a communication request event, the request acquiring module is configured to acquire the request event and a communication identifier of a second electronic device contained in the request event when the communication request event transmitted from the second electronic device is detected; or acquire the request event and a communication identifier of a second electronic device contained in the request event when the communication request event transmitted to the second electronic device is detected.

Preferably, in a case where the request event is a network data request event and the request identifier is a network identifier, the information searching module is configured to search for stored historical network data of a historical access record of a request object corresponding to the network identifier; and
the information outputting module is configured to output the historical network data when the network data request event has not been responded successfully.

It can be seen from the above technical solution that, compared with the prior art, in the information outputting method and electronic device provided by the present disclosure, the request event and the request identifier contained in the request event are acquired and prestored historical record information of the request object corresponding to the request identifier is found, therefore, the historical record information can be output and displayed when the request event has not been responded successfully. In this way, time and device resource are made full use of, the amount of information output is increased, user experience is enhanced, and the user can obtain more information about the request object.

### BRIEF DESCRIPTION OF THE DRAWINGS

In order to more clearly illustrate technical solutions of the embodiments of the present disclosure or the prior art, accompanying drawings to be used in the description of the embodiments or the prior art are briefly described below. Obviously, the accompanying drawings in the following description are only embodiments of the present disclosure, and other accompanying drawings may be obtained by those skilled in the art according to the accompanying drawings provided herein without any creative work.

FIG. 1 is a flow chart of a first embodiment of an information outputting method in accordance with the present disclosure;

FIG. 2 is a flow chart of a second embodiment of an information outputting method in accordance with the present disclosure;

FIG. 3 is a flow chart of a third embodiment of an information outputting method in accordance with the present disclosure;

FIG. 4 is a flow chart of a fourth embodiment of an information outputting method in accordance with the present disclosure;

FIG. 5 is a schematic structural diagram of a first embodiment of an electronic device in accordance with the present disclosure;

FIG. 6 is a schematic structural diagram of a second embodiment of an electronic device in accordance with the present disclosure; and

FIG. 7 is a schematic structural diagram of a third embodiment of an electronic device in accordance with the present disclosure.

### DETAILED DESCRIPTION

In the following, technical solutions of the embodiments of the present disclosure will be described clearly and completely in conjunction with the accompanying drawings of the embodiments of the present disclosure. Obviously, the described embodiments are only part of embodiments of the present disclosure. All other embodiments obtained by those skilled in the art based on these embodiments of the present disclosure without any creative work fall within the scope of protection of the present disclosure.

An information outputting method and an electronic device are provided by the embodiments of the present disclosure. In the information outputting method and electronic device, a request event and a request identifier contained in the request event are acquired and prestored historical record information of a request object corresponding to the request identifier is found, therefore, the historical record information can be output and displayed when the request event has not been responded successfully. In this way, time and device resource are made full use of, the amount of information output is increased, user experience is enhanced, and the user can obtain more information about the request object.

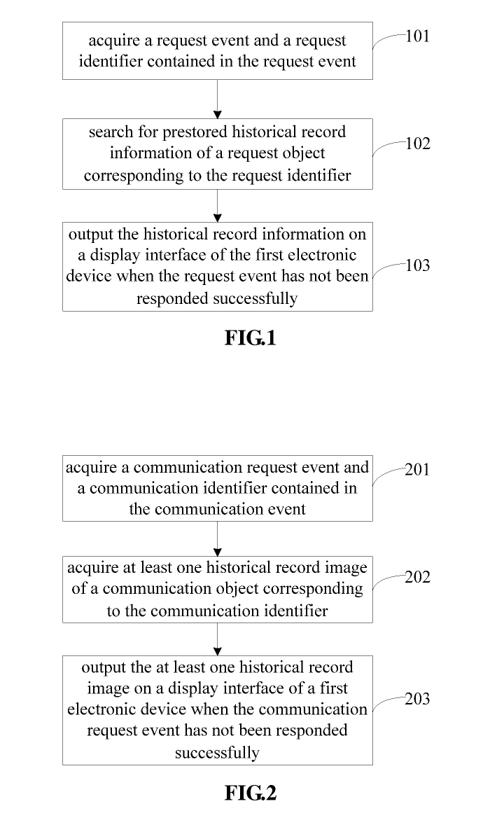

FIG. 1 is a flow chart of a first embodiment of an information outputting method in accordance with the present disclosure. In this embodiment, the method is applied to a first electronic device, and the method may include the following steps 101 to 103.

Step 101: acquiring a request event and a request identifier contained in the request event.

The request event may be a communication request event or a network data request event.

In a case where the request event is a communication request event, which may be, for example, a voice communication request event or a video communication request event, the request identifier is a communication identifier of a second electronic device communicating with the first electronic device, for example, a communication number or a device identifier code.

In a case where the request event is a network data request event, the request identifier is a network identifier, for example, a network address, an instant messenger (IM) account or a microblog account. The network data request event is a request event for acquiring network information corresponding to the network identifier, for example, specific webpage information, microblog information or an instant message.

Step 102: searching for prestored historical record information of a request object corresponding to the request identifier.

The request object may be a communication object, for example, an operating user of the second electronic device communicating with the first electronic device, i.e., a communication user using the second electronic device, where the communication identifier and the communication user are stored in correspondence relationship in the first electronic device. The request object may also be a user initiating the network data request event.

In the embodiment, the historical record information of the request object may be prestored. The historical record information may be obtained from data acquired according to a historical request event of the request object.

The historical record information may be, for example, historical communication record information, historical record images of the request object, and requested historical network data, which will be described in detail below.

Step 103: outputting the historical record information on a display interface of the first electronic device when the request event has not been responded successfully.

In the embodiment, the request event has not been responded successfully refers to that the first electronic device is currently waiting for a response to the request event, for example, waiting for establishment of a communication data channel for the communication request event, or waiting for network connection or webpage content refresh for the network data request event.

The first electronic device is in a waiting state when the request event has not been responded successfully. Therefore, in order to avoid resource waste and poor user experience due to long waiting time, in the embodiment, searched historical record information of the request object may be output and displayed on the display interface of the first electronic device when the request event has not been responded successfully, thus the operating user of the first electronic device may view the historical interaction information with the request object of the request event, thereby increasing the amount of information, making full use of time, and facilitating the user to perform a further operation.

In the embodiment, once the request event is acquired, historical record information of the request object corresponding to the request identifier of the request event may be found, and output and displayed when the request event has not been responded successfully, i.e., when the first electronic device is in a response waiting state. Therefore, time and device resource are made full use of, the amount of information output is increased, user experience is enhanced, and the user can obtain more information about the request object conveniently.

FIG. 2 is a flow chart of a second embodiment of an information outputting method in accordance with the present disclosure. The solution described in the embodiment is applied to a second electronic device. In the embodiment, provided that the request event is a communication request event, the technical solution of the present disclosure will be described in detail below. The method may include the following steps 201 to 203.

Step 201: acquiring a communication request event and a communication identifier contained in the communication request event.

The communication request event may be a communication request event transmitted from the second electronic device and detected by a first electronic device, that is, an event that the second electronic device requests to establish a communication data channel with the first electronic device.

The communication event may also be a communication request event transmitted to the second electronic device and detected by the first electronic device, that is, an event that the first electronic device requests to establish a communication data channel with the second electronic device.

Therefore, the acquiring a request event and a request identifier contained in the request event may include:

acquiring the request event and a communication identifier of the second electronic device contained in the request event when the communication request event transmitted from the second electronic device is detected; or

acquiring the request event and a communication identifier of the second electronic device contained in the request event when the communication request event transmitted to the second electronic device is detected.

The communication request event generally carries a communication identifier, and the communication identifier may be used to uniquely identify the second electronic device or a user using the second electronic device.

Therefore, once the communication request event is acquired, the communication identifier contained in the communication request event may be acquired.

Step 202: acquiring at least one historical record image of a communication object corresponding to the communication identifier.

The historical record image is obtained from video data of the latest video communication record corresponding to the communication object.

The communication object corresponding to the communication identifier may be an operating user of the second electronic device which establishes a communication data channel with the first electronic device. The communication object and the communication identifier are stored in the first electronic device in correspondence relationship, and a communication object can be uniquely determined based on a communication identifier.

In the embodiment, the historical record information is a historical record image which may contain image content of the communication object, such as a head picture of the user. The historical record image is obtained from video data transmitted in the historical video communication corresponding to the communication object.

The historical record image may be acquired in multiple ways. The first electronic device may store historical video data of the historical video communication record corresponding to the communication object, and the video data is composed of successive video image frames. Therefore, when the communication object initiates a request event, at least one image may be extracted from the video data as the historical record image, and the acquiring at least one historical record image of the communication object corresponding to the communication identifier may include:

searching for stored historical video data of the historical video communication record of the communication object corresponding to the communication identifier; and

extracting at least one historical record image from the historical video data.

In order to acquire immediate information, the extracting at least one historical record image from the historical video data may include: determining the latest historical video data of the latest video communication record of the communication object; and extracting at least one historical record image from the latest historical video data.

The first electronic device may also store a historical record image of the communication object. That is, when performing a video communication with the communication object, at least one image is intercepted from video data transmitted in real time and stored as the historical record image of the communication object. Therefore, the historical record image can be searched directly for subsequent request events of the communication object.

Step 203: outputting the at least one historical record image on a display interface of the first electronic device when the communication request event has not been responded successfully.

The communication request event has not been responded successfully refers to that the first electronic device is in a response waiting state. In a case where the communication request event is transmitted from the first electronic device to the second electronic device, the communication request event has not been responded successfully refers to that the first electronic device is in a call waiting state. In a cast where the communication request event is a communication request event transmitted from the second electronic device and received by the first electronic device, the communication request event has not been responded successfully refers to that the first electronic device is in an incoming call waiting state.

In the embodiment, in the response waiting time, the historical record image corresponding to the communication object using the second electronic device is output and displayed on the display interface of the first electronic device. Therefore, the user can further determine whether the communication object is right, and obtain more information according to the output historical record image. In this way, the waiting time is made full use of, the amount of information output is increased, user experience is enhanced, and the user can obtain more information about the communication object conveniently.

The historical record images may be output dynamically and circularly, to indicate a communication waiting state.

While outputting the historical record image in the response waiting time, the first electronic device may also output normal communication event prompting information which may include, for example, the communication identifier, user name of the communication object, and some basic communication operation prompting information such as information for prompting whether to enable mute, speakerphone, call refuse, call forwarding and call holding.

In order that the user can know the duration for waiting the response, the historical record images may be output dynamically on the display interface of the first electronic device at a predetermined output speed. In a case where the historical record images only include one image or a limited number of images, the historical record images are output repeatedly, so that the historical record images output and displayed on the display interface may indicate response waiting progress and reflect the duration of response waiting. For example, provided that one image is output for one second, two images are on the display interface after two seconds, three images are on the display interface after three seconds, and so on. The images output and displayed on the display interface may be the same due to the limited number of the historical record images.

If there is no display space on the display interface due to the limited size of the display interface, the current displayed images may be deleted and the images are output again at the predetermined output speed, until the request is responded successfully; or if there is no display space on the display interface, images are not output any more.

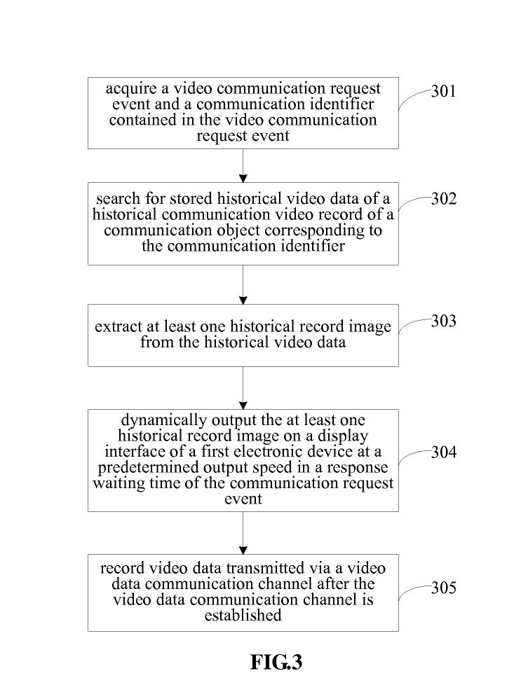

FIG. 3 is a flow chart of a third embodiment of an information outputting method in accordance with the present disclosure. The technical solution of the embodiment is applied to a first electronic device which is specifically a communication device. In the embodiment, provided that the request event is a video communication event, the technical solution of the present disclosure will be described in detail below. The method may include the following steps 301 to 305.

Step 301: acquiring a video communication request event and a communication identifier contained in the video communication request event.

The acquiring a video communication request event and a request identifier contained in the video communication request event may include:

acquiring the video communication request event and a communication identifier of a second electronic device contained in the request event when the video communication request event transmitted from the second electronic device is detected; or

acquiring the video communication request event and a communication identifier of a second electronic device contained in the request event when the video communication request event transmitted to the second electronic device is detected.

Step 302: searching for stored historical video data of a historical communication video record of a communication object corresponding to the communication identifier.

In the embodiment, the historical video data may be a video composed of successive video image frames, that is, the stored video data transmitted via a video communication channel after the historical video communication channel is established.

Step 303: extracting at least one historical record image from the historical video data.

In order to acquire immediate information, the latest historical video data of the latest video communication record of the communication object may be determined, and at least one historical record image may be extracted from the latest historical video data.

As another embodiment, the historical video data may be historical video data of multiple video communication records, therefore, the at least one historical record image may be formed by respectively extracting images from the historical video data of the multiple video communication records.

Step 304: dynamically outputting the at least one historical record image on a display interface of the first electronic device at a predetermined output speed in a response waiting time of the communication request event.

Step 305: recording video data transmitted via a video data communication channel after the video data communication channel is established when the video communication request event has been responded successfully.

The recorded video data is used as historical video data of a next communication request event of the communication object.

After the current video data is recorded, the historical video data of previous historical communication record may be deleted, to avoid resource waste.

In the embodiment, after the video communication event and the communication identifier of the video communication event are acquired, the historical video data of the historical video communication record of the communication object corresponding to the communication identifier may be found. Therefore, a historical record image may be extracted from the historical video data, and the historical record image may be output dynamically on the display interface when waiting for establishment of the video communication channel. In this way, time and device resource are made full use of, the amount of information output is increased, and the user can know more about the communication object conveniently. In addition, by indicating the communication waiting progress with dynamical images, user experience is further enhanced.

As another embodiment, after the video data communication channel is established, a predetermined number of images corresponding to the communication object may be extracted from video data transmitted via the video data communication channel, and stored as the historical record images, so that after the video communication request event is received again and the communication identifier is accordingly acquired, the stored at least one historical record image of the communication object corresponding to the communication identifier may be found directly.

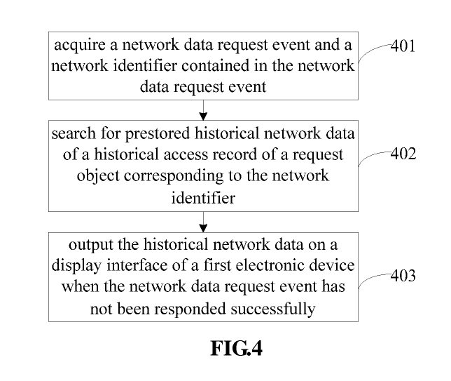

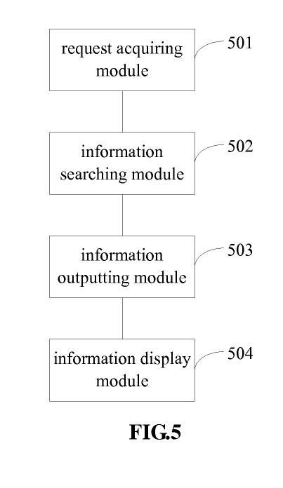

FIG. 4 is a flow chart of a fourth embodiment of an information outputting method of the present disclosure. The technical solution of the embodiment is mainly applied to a first electronic device. In the embodiment, provided that the request event is a network data request event, the technical solution of the present disclosure will be described in detail below. The method may include the following steps 401 to 403.

Step 401: acquiring a network data request event and a network identifier contained in the network data request event.

The network identifier may be, for example, a network address, an IM account or a microblog account. Accordingly, the network data request event is a request event for acquiring network information corresponding to the network identifier, for example, specific webpage information, microblog information or an instant message.

Step 402: searching for prestored historical network data of a historical access record of a request object corresponding to the network identifier.

The request object may be an object corresponding to the network data requested by the user initiating the network data request event, for example, a requested specific webpage containing network data, an IM contact person who is an IM user corresponding to an IM account, or a microblog user who is a user corresponding to a microblog account.

The historical network data of the historical access record is stored network data of the request object previously accessed, and may be, for example, a historical IM message, historical microblog content and historical webpage content of the request object.

In order to acquire immediate information, the searching for prestored historical network data of a historical access record of the request object corresponding to the network identifier may include searching for prestored historical network data of the latest historical access record of the request object corresponding to the network identifier.

Step 403: outputting the historical network data on a display interface of the first electronic device when the network data request event has not been responded successfully.

The network data request event has not been responded successfully may refer to that the first electronic device is in a state for waiting response to the request event, or the first electronic device is in a state for waiting network connection or webpage content refresh. Therefore, the latest historical network data of the request object may be output and displayed in the response waiting time, thereby making full use of time and increasing the amount of information output.

In the embodiment, once the network data request event is acquired, the historical network data of the historical network access record of the request object determined by the network data request event may be output on the display interface of the first electronic device when waiting for a response to the network data request event. Therefore, the event is made full use of, the amount of information output is increased, user experience is enhanced, and the user can obtain more information about the request object conveniently.

FIG. 5 is a schematic structural diagram of a first embodiment of an electronic device in accordance with the present disclosure. The electronic device may include the following modules.

A request acquiring module 501 is configured to acquire a request event and a request identifier contained in the request event.

The request event may be a communication request event or a network data request event.

In a case where the request event is a communication request event, which may be, for example, a voice communication request event or a video communication request event, the request identifier is a communication identifier of a second electronic device communicating with the first electronic device, for example, a communication number or a device identifier code.

In a case where the request event is a network data request event, the request identifier is a network identifier, for example, a network address, an IM account or a microblog account.

In a case where the request event is a communication event, the request acquiring module is configured to acquire the communication request event and a communication identifier of the second electronic contained in the communication request event when the communication request event transmitted from the second electronic device is detected; or acquire the communication request event and a communication identifier of the second electronic device contained in the communication request event when the communication request event transmitted to the second electronic device is detected.

An information searching module 502 is configured to search for prestored historical record information of a request object corresponding to the request identifier.

The request object may be a communication object, for example, an operating user of the second electronic device communicating with the first electronic device, i.e., a communication user using the second electronic device, where the communication identifier and the communication user are stored in correspondence relationship in the first electronic device. The request object may also be a user initiating the network data request event.

The historical record information may be, for example, historical communication record information, a historical record image of the request object, or the requested historical network data.

As a possible implementation, in a case where the request event is a communication request event and the request identifier is a communication identifier, the information searching module may be configured to acquire at least one historical record image of the communication object corresponding to the communication identifier, where the historical record image is obtained from video data transmitted in the historical video communication corresponding to the communication object. The historical record image may include image content of the communication object, such as a head picture of the user.

The historical record image may be acquired in multiple ways. As a possible implementation, the information searching module may include:

a data searching module, configured to search for stored historical video data of a historical communication video record of a communication object corresponding to the communication identifier; and

a first extraction module, configured to extract at least one historical record image from the historical video data.

In order to acquire immediate information, the first extraction module may be configured to search for the latest historical video data of the latest historical communication video record of the communication object corresponding to the communication identifier, and extract at least one historical record image from the latest historical video data.

As another possible implementation, the electronic device may store the historical record images of the communication object. That is, when performing a video communication with the communication object, at least one image is intercepted from video data transmitted in real time and then stored as the historical record image of the communication object. Therefore, the historical record image can be searched directly for subsequent request events of the communication object.

As a possible implementation, in a case where the request event is a network data request event, the information searching module may be configured to search for the stored historical network data of a historical access record of a request object corresponding to the network identifier. In order to acquire immediate information, the information searching module may search for the stored historical network data of the latest historical access record of the request object corresponding to the network identifier.

An information outputting module 503 is configured to output the historical record information when the request event has not been responded successfully.

In the embodiment of the present disclosure, the request event has not been responded successfully may refer to that the first electronic device is currently in a state for waiting response to the request event, for example, a state for waiting establishment of a communication data channel for the communication request event, or a state for waiting network connection or webpage content refresh for the network data request event.

The first electronic device is in a waiting state when the request event has not been responded successfully. Therefore, in order to avoid resource waste and poor user experience due to long waiting time, in the embodiment, searched historical record information of the request object may be output and displayed on the display interface of the first electronic device when the request event has not been responded successfully, thus the operating user of the first electronic device may view the historical interaction information with the request object of the request event. In this way, the amount of information is increased, the time is made full use of, and the user can know more information about the request object conveniently.

In a case where the request event is a communication request event and the historical record information is at least one historical record image, the information outputting module 503 may be configured to output the at least one historical record image when the communication request event has not been responded successfully.

In order that the user can know the duration for waiting the response, the information outputting module may be configured to dynamically output the at least one historical record image on the display interface of the first electronic device at a predetermined output speed in the response waiting time of the communication request event, where the number of the output historical record images is used to indicate response waiting progress.

In a case where the request event is a network data request event and the historical record information is historical network data of a historical access record of a request object corresponding to the network identifier, the information outputting module may be configured to output the historical network data when the network data request event has not been responded successfully.

An information display module 504 is configured to display the historical record information output from the information outputting module.

In the embodiment, once the request event is acquired by the electronic device, the historical record information of the request object corresponding to the request identifier of the request event is found, and is output and displayed when the request event has not been responded successfully, i.e., the first electronic device is in the response waiting state. Therefore, time and device resource are made full use of, time and the device resource waste is avoided, the amount of information output is increased, user experience is enhanced, and the user can obtain more information about the request object conveniently.

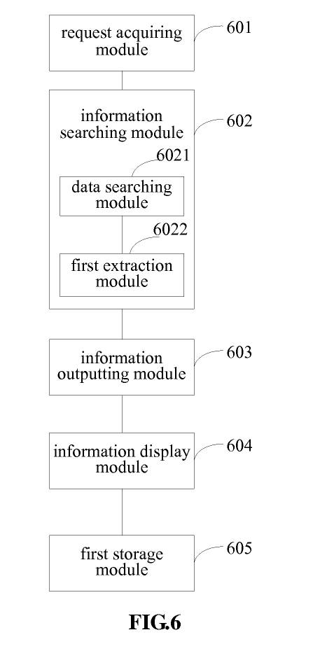

FIG. 6 is a schematic structural diagram of a second embodiment of an electronic device in accordance with the present disclosure. The electronic device may include the following modules.

A request acquiring module 601 is configured to acquire a video communication request event and a communication identifier contained in the communication request event.

In the embodiment, provided that the request event is a video communication event, the technical solution of the present disclosure will be described in detail.

The request acquiring module may be configured to acquire the video communication request event and a communication identifier of a second electronic device contained in the request event when the video communication request event transmitted from the second electronic device is detected; or acquire the video communication request event and a communication identifier of a second electronic device contained in the request event when the video communication request event transmitted to the second electronic device is detected.

An information searching module 602 is configured to acquire at least one historical record image of a communication object corresponding to the communication identifier, where the historical record image is obtained from video data transmitted in a historical video communication corresponding to the communication object.

As a possible implementation, the information searching module 602 may include a data searching module 6021 and a first extraction module 6022.

The data searching module 6021 is configured to search for stored historical video data of a historical communication video record of a communication object corresponding to the communication identifier.

In this case, the historical video data may be a video composed of successive video image frames, that is, the stored video data transmitted via a historical video communication channel after the historical video communication channel is established.

The first extraction module 6022 is configured to extract at least one historical record image from the historical video data.

In order to acquire immediate information, the first extraction module may be configured to determine the latest historical video data of the latest video communication record of the communication object, and extract at least one historical recoded image from the latest historical video data.

The historical video data may be historical video data of multiple video communication records, therefore, the at least one historical record image may be formed by respectively extracting images from the historical video data of the multiple video communication records.

An information outputting module 603 is configured to dynamically output the at least one historical record image on a display interface of the first electronic device at a predetermined output speed in the response waiting time of the communication request event.

An information display module 604 is configured to display the at least one historical record image output from the information outputting module.

A first storage module 605 is configured to record video data transmitted via a video data communication channel after the video data communication channel is established when the video communication request event has been responded successfully.

The recorded video data is used as historical video data of the next communication request event of the communication object.

After the current video data is recorded, the historical video data of previous historical communication records may be deleted, thereby avoiding resource waste.

In the embodiment, the video communication event and the communication identifier of the video communication event are acquired, and the historical video data of the historical video communication record of the communication object corresponding to the communication identifier may be found. Therefore, the historical record image may be extracted from the historical video data, and the historical record image may be output dynamically when waiting for establishment of the video communication channel. In this way, time and device resource are made full use of, the amount of information output is increased, and the user can know more about the communication object conveniently. In addition, by indicating the communication waiting progress with dynamical images, user experience is further enhanced.

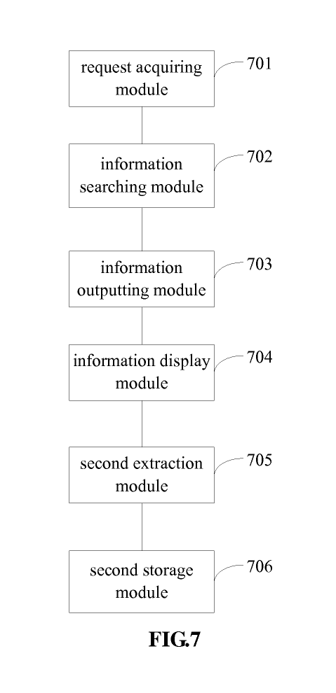

As another embodiment, FIG. 7 is a schematic structural diagram of a third embodiment of an electronic device in accordance with the present disclosure. The electronic device includes the following modules.

A request acquiring module 701 is configured to acquire a communication request event and a communication identifier contained in the communication request event.

In the embodiment, provided that the request event is a video communication event, the technical solution of the present disclosure will be described in detail below.

An information searching module 702 is configured to acquire at least one historical record image of a communication object corresponding to the communication identifier, where the historical record image is obtained from video data transmitted in a historical video communication corresponding to the communication object.

An information outputting module 703 is configured to dynamically output the at least one historical record image on a display interface of a first electronic device at a predetermined output speed in a response waiting time of the communication request event.

An information display module 704 is configured to display the at least one historical record image output from the information outputting module.

A second extraction module 705 is configured to extract a predetermined number of images corresponding to the communication object from video data transmitted via a video data communication channel after the video data communication channel is established when the video communication request has been responded successfully.

A second storage module 706 is configured to store the predetermined number of images corresponding to the communication object extracted by the second extraction module as historical record images.

In the embodiment, the video communication event and the communication identifier of the video communication event are acquired, and the historical record image of the communication object corresponding to the communication identifier may be acquired. The historical record image may be output dynamically when waiting for establishment of the video communication channel, where the historical record image is obtained by intercepting the video data transmitted in the historical video communication of the communication object and then is stored. Therefore, time and device resource are made full use of, the amount of information output is increased, and the user can know more about the communication object conveniently. In addition, by indicating the communication waiting progress with dynamical images, user experience is further improved.

The embodiments of the present disclosure are described in a progressive manner, and each embodiment places emphasis on the difference from other embodiments, therefore, one embodiment can refer to other embodiments for the same or similar parts. The device embodiments correspond to the method embodiments, thus the description thereof is simple, and the related parts can refer to the description of the method embodiments.

The above description of the embodiments enables those skilled in the art to implement or use the present disclosure. Various modifications to these embodiments are apparent to those skilled in the art, and the general principle defined herein may be implemented in other embodiments without deviating from the spirit or scope of the present disclosure. Therefore, the present disclosure is not limited to these embodiments described herein, but in accordance with the widest scope consistent with the principle and novel features disclosed herein.

1. An information outputting method, which is applied to a first electronic device, the method comprising:
acquiring a request event and a request identifier contained in the request event;
searching for prestored historical record information of a request object corresponding to the request identifier; and
outputting the historical record information on a display interface of the first electronic device when the request event has not been responded successfully.

2. The method according to claim 1, wherein in a case where the request event is a communication request event and the request identifier is a communication identifier, the searching for historical record information of a request object corresponding to the request identifier comprises:
acquiring at least one historical record image of a communication object corresponding to the communication identifier, wherein the historical record image is obtained from video data transmitted in a historical video communication corresponding to the communication object; and
the outputting the historical record information on a display interface of the first electronic device when the request event has not been responded successfully comprises:
outputting the at least one historical record image on the display interface of the first electronic device when the communication request event has not been responded successfully.

3. The method according to claim 2, wherein the acquiring at least one historical record image of a communication object corresponding to the communication identifier comprises:
searching for stored historical video data of a historical communication video record of the communication object corresponding to the communication identifier; and
extracting at least one historical record image from the historical video data.

4. The method according to claim 3, wherein the extracting at least one historical record image from the historical video data comprises:
determining the latest historical video data of the latest video communication record of the communication object, and extracting at least one historical record image from the latest historical video data.

5. The method according to claim 2, wherein the outputting the at least one historical record image on the display interface of the first electronic device when the communication request event has not been responded successfully comprises:
dynamically outputting the at least one historical record image on the display interface of the first electronic device at a predetermined output speed in a response waiting time of the communication request event, wherein the number of the historical record images output on the display interface indicates response waiting progress.

6. The method according to claim 2, wherein in a case where the communication request event is a video communication request event, the method further comprises, after outputting the at least one historical record image on the display interface of the first electronic device,
recording video data transmitted via a video data communication channel after the video data communication channel is established when the video communication request event has been responded successfully.

7. The method according to claim 2, wherein in a case where the communication request event is a video communication request event, the method further comprises, after outputting the at least one historical record image on the display interface of the first electronic device,
extracting, from video data transmitted via a video data communication channel, and storing a predetermined number of images corresponding to the communication object after the video data communication channel is established when the video communication request event has been responded successfully.

8. The method according to claim 3, wherein in a case where the communication request event is a video communication request event, the method further comprises, after outputting the at least one historical record image on the display interface of the first electronic device,
extracting, from video data transmitted via a video data communication channel, and storing a predetermined number of images corresponding to the communication object after the video data communication channel is established when the video communication request event has been responded successfully.

9. The method according to claim 1, wherein in a case where the request event is a communication request event, the acquiring a request event and a request identifier contained in the request event comprises:
acquiring the communication request event and a communication identifier of a second electronic device contained in the communication request event when the communication request event transmitted from the second electronic device is detected; or
acquiring the communication request event and a communication identifier of a second electronic device contained in the communication request event when the communication request event transmitted to the second electronic device is detected.

10. The method according to claim 2, wherein in a case where the request event is a communication request event, the acquiring a request event and a request identifier contained in the request event comprises:
acquiring the communication request event and a communication identifier of a second electronic device contained in the communication request event when the communication request event transmitted from the second electronic device is detected; or
acquiring the communication request event and a communication identifier of a second electronic device contained in the communication request event when the communication request event transmitted to the second electronic device is detected.

11. The method according to claim 1, wherein in a case where the request event is a network data request event and the request identifier is a network identifier, the searching for prestored historical record information of a request object corresponding to the request identifier comprises:
searching for stored historical network data of a historical access record of the request object corresponding to the network identifier; and
the outputting the historical record information on a display interface of the first electronic device when the request event has not been responded successfully comprises:
outputting the historical network data on the display interface of the first electronic device when the network data request event has not been responded successfully.

12. An electronic device, comprising:
a request acquiring module, configured to acquire a request event and a request identifier contained in the request event;
an information searching module, configured to search for prestored historical record information of a request object corresponding to the request identifier;
an information outputting module, configured to output the historical record information when the request event has not been responded successfully; and
an information display module, configured to display the historical record information outputted from the information outputting module.

13. The electronic device according to claim 12, wherein in a case where the request event is a communication request event and the request identifier is a communication identifier, the information searching module is configured to acquire at least one historical record image of the communication object corresponding to the communication identifier, wherein the historical record image is obtained from video data transmitted in a historical video communication corresponding to the communication object; and
the information outputting module is configured to output the at least one historical record image when the communication request event has not been responded successfully.

14. The electronic device according to claim 13, wherein the information searching module comprises:
a data searching module, configured to search for stored historical video data of a historical communication video record of the communication object corresponding to the communication identifier; and
a first extraction module, configured to extract at least one historical record image from the historical video data.

15. The electronic device according to claim 13, wherein the information outputting module is configured to dynamically output the at least one historical record image on a display interface of a first electronic device at a predetermined output speed in a response waiting time of the communication request event, wherein the number of the historical record images displayed on the information display module indicates response waiting progress.

16. The electronic device according to claim 13, wherein in a case where the communication request event is a video communication request event, the electronic device further comprises:
a first storage module, configured to record video data transmitted via a video data communication channel after the video data communication channel is established when the video communication request event has been responded successfully.

17. The electronic device according to claim 13, wherein in a case where the communication request event is a video communication request event, the electronic device further comprises:
a second extraction module, configured to extract a predetermined number of images corresponding to the communication object from video data transmitted via a video data communication channel after the video data communication channel is established when the video communication request event has been responded successfully; and
a second storage module, configured to store the predetermined number of images corresponding to the communication object extracted by the second extraction module as the historical record images.

18. The electronic device according to claim 14, wherein in a case where the communication request event is a video communication request event, the electronic device further comprises:
a second extraction module, configured to extract a predetermined number of images corresponding to the communication object from video data transmitted via a video data communication channel after the video data communication channel is established when the video communication request event has been responded successfully; and
a second storage module, configured to store the predetermined number of images corresponding to the communication object extracted by the second extraction module as the historical record images.

19. The electronic device according to claim 12, wherein in a case where the request event is a communication request event, the request acquiring module is configured to acquire the communication request event and a communication identifier of a second electronic device contained in the communication request event when the communication request event transmitted from the second electronic device is detected; or acquire the communication request event and a communication identifier of a second electronic device contained in the communication request event when the communication request event transmitted to the second electronic device is detected.

20. The electronic device according to claim 12, wherein in a case where the request event is a network data request event and the request identifier is a network identifier, the information searching module is configured to search for stored historical network data of a historical access record of the request object corresponding to the network identifier; and
the information outputting module is configured to output the historical network data when the network data request event has not been responded successfully.
